(19) United States
(12) Patent Application Publication
(10) Pub. No.: US 2025/0303565 A1
(43) Pub. Date: Oct. 2, 2025

(54) METHOD FOR PREPARING AND CARRYING OUT TASKS BY MEANS OF A ROBOT, ROBOT, AND COMPUTER PROGRAM

(71) Applicant: Deutsches Zentrum für Luft- und Raumfahrt e.V., Bonn (DE)

(72) Inventors: Samuel Bustamante Gomez, Weßling (DE); Ismael Valentin Rodriguez Brena, Weßling (DE); Daniel Leidner, Weßling (DE); Jörn Vogel, Weßling (DE)

(21) Appl. No.: 18/863,253

(22) PCT Filed: May 5, 2023
(86) PCT No.: PCT/EP2023/061892

§ 371 Date: Nov. 5, 2024

(30) Foreign Application Priority Data
May 6, 2022 (DE) 10 2022 111 400.7

(51) Int. Cl. B25J 9/16

(52) U.S. Cl. CPC B25J 9/1661

(57) ABSTRACT

The invention relates to a method for preparing and carrying out tasks by means of a robot, in which method, in a preparation phase at least one probable action goal is determined on the basis of surroundings information and taking into account a user command probability, at least one preparation action sequence is generated which is aimed at the at least one probable action goal, and the at least one preparation action sequence is carried out. The invention also relates to a robot for carrying out tasks, and to a computer program.

This application is a national stage application of PCT Patent Appln. No. PCT/EP2023/061892 filed May 5, 2023, which claims priority to DE Patent Appln. No. 10 2022 111 400.7 filed May 6, 2022, which are herein incorporated by reference.

### BACKGROUND OF THE INVENTION

### 1. Technical Field

The invention relates to a method for preparing and carrying out tasks by means of a robot. The invention also relates to a robot for carrying out tasks. The invention also relates to a computer program.

### 2. Background Information

Document DE 10 2017 209 032 A1 relates to a method for controlling a robot. In order to simplify a selection by a user of an action to be carried out by the robot, document DE 10 2017 209 032 A1 proposes to determine various actions that may be performed by the robot, to restrict the actions that may be performed by the robot according to at least one precondition, and to display this restricted number of actions that may be performed by the robot on a display device so that the user may select an action to be carried out from this restricted number.

Document DE 10 2021 104 883 B3 relates to a method for robot-assisted carrying out of tasks, wherein a robot is controlled in a shared manner in a first support mode by means of a user module and is controlled autonomously under user supervision in a second support mode by means of an automation module. In order to enable user-triggered, adjustable autonomy, particularly in the context of assistive robotics, the user module and the automation module are represented within a shared control module and use the same action representation.

The German patent application with the official file number 10 2022 104 525.0, filed on Feb. 25, 2022, relates to a method for carrying out tasks by means of a robot, wherein the robot is controlled in a first execution mode and in at least one further execution mode, wherein an action sequence aimed at an action goal is generated and carried out and the same action representations are used to control the robot in the first execution mode and in the at least one further execution mode.

### SUMMARY OF THE INVENTION

The invention is based on the task of providing or structurally and/or functionally improving an aforementioned method. The invention is, moreover, based on the task of providing or structurally and/or functionally improving an aforementioned robot. The invention is, moreover, based on the task of providing or structurally and/or functionally improving an aforementioned computer program.

The task is solved with a method having the features of claim 1. The problem is, moreover, solved with a robot having the features of claim 9. The problem is, moreover, solved with a computer program having the features of claim 10. Advantageous implementations and/or further developments are the subject matter of the independent claims.

The method may be used to control the robot. “Control” in this context refers, in particular, to control engineering and/or control technology. Tasks to be carried out may be tasks that a user and/or a robot may carry out. Tasks to be carried out may be tasks in which a robot supports a user. The method may serve to control the robot in cooperation with a human user, which user employs the robot to assist in carrying out tasks (robotic tasks with a human-in-the-loop, RTHL). The method may be carried out using at least one processor. The method may be carried out by means of a control device of the robot.

An action goal may be a carrying out or fulfillment of a specific task. An action goal may be an overall goal. An action goal may be achievable by carrying out suitable actions. An action goal may be achieved by sequentially carrying out suitable actions. The actions to be carried out and/or carried out to achieve the action goal may form an action sequence. An action sequence may comprise the actions to be carried out and/or carried out to achieve the action goal or be formed by these actions. An action sequence may be generated in a planning phase. An action sequence may be generated by creating, selecting, compiling, stringing together, listing and/or ordering. An action sequence may be a symbolic plan. The symbolic plan may comprise all the symbolic transitions required to achieve an action goal. An action sequence may be generated by means of a symbolic planner. An action sequence aimed at an action goal may be an action sequence set out to fulfill the action goal. An action sequence may be generated and/or carried out to achieve the action goal. An action sequence may be neither predetermined nor fixed. An action sequence may be planned to achieve an action goal. An action sequence may be planned individually to achieve a specific action goal. At least one action and at least one further action of the action sequence may be carried out at least partially in parallel to each other.

The surroundings information may be generated and/or provided by means of a mathematical model. The surroundings information may be generated and/or provided by means of a mathematical model of the environment. The surroundings may comprise the robot, parts of the robot and/or objects present in a working area of the robot. Surroundings information may be information relating to the robot, parts of the robot and/or objects present in a working area of the robot. Surroundings information may relate to information about a state of the robot, to a state of parts of the robot and/or to a state of objects present in a working area of the robot at a certain point in time. Surroundings information may describe instantaneous properties of the robot, of parts of the robot and/or of objects present in a working area of the robot.

The surroundings information may be used in an action sequence. The surroundings information may be generated, provided and/or used as object definitions. Data used to generate an action sequence may be referred to as input data. Input data may comprise action definitions and/or object definitions. Action definitions may define actions. The actions may be part of an action sequence. Object definitions may define objects. Object definitions may include surroundings information.

An action goal may be determined taking into account a user command. A user command may be based on an input and/or on a selection by a user. A user command may be an input or a selection of an action goal by a user.

The user command probability may be a probability with which an action goal will be input or selected by a user. The user command probability may be determined taking into consideration surroundings information. A probable action goal may be an action goal that a user will probably input or select. A probable action goal may be a specific task that a user will probably carry out or fulfill.

The following steps may be performed for a selection by the user: determination of possible action goals, restricting a number of the determined possible action goals taking into account at least one precondition, and/or offering of the restricted number of action goals to allow the user to make a selection. The restricted number of action goals may be offered to the user by displaying them on a display device. The precondition may be a global precondition, which provides in particular that an action sequence aimed at an action goal may only first be carried out after a required preceding action sequence has been completed. The precondition may provide that an action sequence may be completed with a restricted number of actions, wherein this number may be adjustable. An action sequence may be defined as an exception and be offered to the user for selection even though the number of actions required to complete this action sequence exceeds an allowable restricted number. The precondition may provide that only action sequences on objects to be manipulated are displayed that are less than an adjustable maximum distance away from the robot. A blacklist with action sequences that are not permissible may be created and the precondition may provide that an action sequence on the blacklist may not be offered to the user for selection. A whitelist with required action sequences may be created and the precondition may provide that an action sequence appearing in the whitelist must be offered to the user for selection. The precondition may provide that the robot may only be used in a restricted spatial area, in particular within the home of the user. The precondition may provide that only action sequences that do not exceed a predetermined energy requirement may be offered to the user for selection.

For further technological background in this regard, reference is made to the publication “D. S. Leidner, Cognitive Reasoning for Compliant Robot Manipulation, ser. Springer Tracts in Advanced robotics. Cham: Springer International Publishing, 2019, vol. 127.”, the features of which are also part of the teachings of the present invention and which are fully incorporated into the disclosure of the present invention.

The method may comprise a preparation phase and an execution phase. The preparation phase may be undergone before the execution phase. The execution phase may be undergone after the preparation phase. The execution phase may be undergone after a user command to carry out a probable action goal. The execution phase may be undergone after a user command to carry out an action goal not determined as a probable action goal, as soon as at least one preparation action sequence aimed at this action goal has been generated and carried out in order to determine object-dependent constraint conditions. Several preparation action sequences may be generated in the preparation phase. In the preparation phase, several preparation action sequences may be generated for the same probable action goal. In the preparation phase, several preparation action sequences may be generated for different probable action goals. The at least one preparation action sequence may be stored. The at least one preparation action sequence may be stored for later modification and/or execution.

The at least one preparation action sequence and/or the at least one execution action sequence may be generated in a planning phase. At least one preliminary action sequence may be generated during/for generation of the at least one preparation action sequence and/or the at least one execution action sequence. The at least one preliminary action sequence may be carried out in simulation and tested in the planning phase. The preliminary action sequence may be tested with different parameters. The at least one preliminary action sequence may be stored. The at least one preliminary action sequence may be stored for later modification and/or execution. An execution phase may be initiated with a user command. A preliminary action sequence may actually be carried out in the execution phase. A preliminary action sequence aimed at an action goal selected by a user may be carried out in real time in the execution phase.

When carrying out the at least one preparatory action sequence, object-dependent constraint conditions may be determined and stored. Object-dependent constraint conditions may be constraint conditions conditioned by environment objects. Environment objects may be the robot, parts of the robot and/or objects present in a working area of the robot. Object-dependent constraint conditions may be constraint conditions existing at a certain point in time. Object-dependent constraint conditions may be constraint conditions caused by the robot, by parts of the robot and/or by objects present in a working area of the robot. A collision check with obstacles may be performed when carrying out the at least one preparation action sequence. The obstacles may be environmental objects. After a user command, in an execution phase, the stored object-dependent constraint conditions may be used in at least one execution action sequence.

Using the same action representations, the robot may be shared in a first support mode and controlled autonomously under user supervision in a second support mode. A support mode may be configured for robot-assisted carrying out of tasks. In the first support mode, the robot may be controlled in a shared manner. In the first support mode, the robot may be controlled in a shared manner by means of a user module. The first support mode may also be referred to as shared control. In the second support mode, the robot may be controlled autonomously under user supervision. In the second support mode, the robot may be controlled autonomously under user supervision by means of at least one automation module. The second support mode may also be referred to as supervised autonomy. The user module and the automation module may be represented within a shared control module. At least one support mode may be configured to carry out teleoperations. At least one support mode may be configured to carry out fully autonomous operations. At least one support mode may be configured for direct control of the robot.

Shared control means, in particular, that the robot, in particular control variables of the robot, may be under shared control of the user by means of a user module and/or under autonomous control by means of an automation module. The robot may be controlled partly by means of a user module and partly by means of an automation module. A division between a control by means of a user module and a control by means of an automation module may be changeable in a controlled manner. A division between a control by means of a user module and a control by means of an automation module may be seamlessly changeable. In this case, “seamless” may in particular mean that a change or a switch takes place without affecting, at least nearly, the carrying out of the task. A proportion of control by means of a user module may be between almost 0% and almost 100% and a proportion of control by means of an automation module may be between almost 100% and almost 0%, wherein a control proportion of a user module and a control proportion of an automation module together always amount to 100%. For example, approximately 10% of the control may be carried out by the user and approximately 90% by the control device of the robot. The robot, in particular the control variables, may be controlled proportionally and/or divided along the degrees of freedom of movement. Shared control may be understood as a compromise between direct control and supervised autonomy, wherein the user only controls part of the task directly and continuously and leaves the rest to the robot.

Supervised autonomy means, in particular, that the user has transferred the carrying out of a task to the robot and the robot carries out the task independently under supervision. Supervised autonomy traditionally comprises two elements: Firstly, declarative knowledge in the form of symbols, which enables the robot to generate an abstract high-level plan. Secondly, procedural knowledge in the form of geometric operations that help the robot to create and carry out low-level plans of motion.

A control module may be a virtual module and/or may comprise virtual structures. The user module and/or the automation module may be a virtual module and/or comprise virtual structures. The user module and/or the automation module may be a structurally and/or functionally distinguishable or definable module. The automation module may be configured to autonomously control the robot. The automation module may be configured to carry out tasks specified by task definitions. The automation module may be configured to generate input commands for autonomous control as an action representation. The user module may be configured to control the robot according to user commands. The user module may be configured to generate input commands for shared control as an action representation.

The control module may plan movements and trajectories in the same virtual structures in the first support mode and in the second support mode. Input commands of the control module may use the same virtual structures in the first support mode and in the second support mode. In the first support mode, the robot may be controlled by a user by means of virtual structures, in particular by means of a user module. The automation module may plan movements and trajectories in the same virtual structures in which a user generates commands. Input commands of the automation module and input commands of the user module may use the same virtual structures.

A shared control module may comprise a user module and an automation module. The automation module may be integrated into the user module. The user module may comprise the automation module. In this respect, a shared control module may also be referred to as a shared control module with integrated autonomy (SCIA).

The user module and the automation module may use the same action representations with their respective input commands. The automation module may use the action representations of the user module. The user module may use an action representation of the automation module. The action representations may be virtual structures and/or comprise virtual structures.

Within the control module, output commands for controlling the robot may be generated based on input commands. Within a shared control module, output commands for controlling the robot may be generated based on input commands of the automation module and/or input commands of the user module. The output commands may also be referred to as robot control signals. The input commands may be commands within the common or shared control module. The input commands may be commands emanating from the control module, for example, from the automation module and/or from the user module. The input commands may be commands from which output commands are generated. The output commands may be generated directly based on input commands of the control module, for example, based on input commands of the automation module and/or based on input commands of the user module. The output commands may be generated without separate output commands of the control module, for example, without separate output commands of the automation module and/or output commands of the user module.

The output commands may be generated according to an active execution mode, for example, according to an active support mode. In the first support mode, the output instructions may be generated based on input instructions of an automation module and/or on input instructions of the user module. In a second support mode, the output commands may be generated based on input commands from the automation module. The output commands may be output commands of the common or shared control module. The output commands may be commands to control the robot. The output commands may be commands sent to the robot to control the robot.

Within the common or shared control module, a switching between the first support mode and the second support mode may be enabled based on input commands of the control module, for example, based on input commands of the automation module and/or based on input commands of the user module. The automation module may be activatable and/or deactivatable. A switching between the first support mode and the second support mode may take place in traded control. In this respect, a shared control with switching between the first support mode and the second support mode may also be referred to as shared and traded control. A trading of the input commands of the automation module and/or of the input commands of the user module may take place within a shared control module, in particular, within virtual structures that a user also uses for inputting.

A switching between the first support mode and the second support mode may be take place by activation/deactivation of the automation module. In the first support mode, the automation module may be deactivated. In the second support mode, the automation module may be activated. The automation module may be deactivated by default. The automation module may be activated and/or deactivated by a user command.

For further technological background in this regard, reference is made to the publications of “S. Bustamante, G. Quere, K. Hagmann, X. Wu, P. Schmaus, J. Vogel, F. Stulp, and D. Leidner, “Toward seamless transitions between shared control and supervised autonomy in robotic assistance,” IEEE robotics and Automation Letters, vol. 6, no. 2, pp. 3833-3840, 2021.” and of “G. Quere, A. Hagengruber, M. Iskandar, S. Bustamante, D. Leidner, F. Stulp, and J. Vogel, “Shared Control Templates for Assistive robotics,” in 2020 IEEE International Conference on robotics and Automation (ICRA), Paris, France, 2020, p. 7.”, the features of which are also part of the teachings of the present invention and are fully incorporated into the disclosure of the present invention.

The stored object-dependent constraint conditions may be used in the first support mode and/or in the second support mode. The robot may be controlled by means of a control module in the first support mode and/or in the second support mode. The control module may be a common control module which is configured to control the robot in the first support mode and in the second support mode. The control module may be a shared control module. A shared control module may comprise a first submodule and at least one further submodule. A shared control module may comprise a first submodule and a second submodule. A first submodule may be configured to control the robot in the first support mode. A further submodule may be configured to control the robot in the second support mode. A first submodule may be configured as a user module. A second submodule may be configured as an automation module. The robot may be assigned different degrees of autonomy in the first support mode and in the second support mode. The robot may be assigned a lower level of autonomy in the first support mode, than in the second support mode. The robot may be assigned a greater degree of autonomy in the second support mode, than in the first support mode. The first support mode and the second support mode may be implemented sequentially, weighted sequentially, parallel and/or weighted parallel.

During/for generation of the at least one preliminary action sequence, suitable action definitions may be selected from a plurality of action definitions. The action definitions may be contained in an action database. The action database may be a central database. Declarative and/or procedural knowledge may be used during/for generation of the action sequence. Declarative and/or procedural knowledge from the action definitions may be used during/for generation of the at least one preliminary action sequence.

Finite state machines (FSMs) may be created in the form of shared control templates (SCTs) during/for generation of the at least one preliminary action sequence. The shared control templates may be configured to generate output commands from input commands of the control module, for example, from input commands of the automation module and/or input commands of the user module. The common or shared control module may use shared control templates. States and transitions may form key elements between shared control templates. Each state may represent a different skill phase. Transitions between states may be triggered when certain predefined events occur between objects of interest in the working area. Input commands of the control module, such as, for example, input commands of the automation module and/or input commands of the user module, may be mapped to task-relevant robot movements by means of the shared control templates. The output commands may be generated by mapping the input commands of the control module, for example, the input commands of the automation module and/or the input commands of the user module, to task-relevant robot movements. A shared control template may support a user in achieving a task by providing object-and task-specific mappings and constraints for each state of a skill. In so doing, the FSM may monitor progress and trigger transitions between the different states.

Autonomy may be implemented within an SCT. The autonomy may use this SCT. The automation module may be defined and transmit input commands to the SCT. While carrying out a task in the SCIA, a control of the robot may always remain within an SCT and an input authority may be switched between the automation module and the user module. This means that the SCT is independent of whether an input command comes from the automation module or from the user module. Regardless of whether the input commands come from the automation module or from the user module, the same state transitions, input assignments, active boundary conditions and/or the same overall control may always be applied.

For further technological background in this regard, please refer to the publications of “S. Bustamante, G. Quere, K. Hagmann, X. Wu, P. Schmaus, J. Vogel, F. Stulp, and D. Leidner, “Toward seamless transitions between shared control and supervised autonomy in robotic assistance,” IEEE robotics and Automation Letters, vol. 6, no. 2, pp. 3833-3840, 2021.” and of “G. Quere, A. Hagengruber, M. Iskandar, S. Bustamante, D. Leidner, F. Stulp, and J. Vogel, “Shared Control Templates for Assistive robotics,” in 2020 IEEE International Conference on robotics and Automation (ICRA), Paris, France, 2020, p. 7.”, the features of which are also part of the teachings of the present invention and which are fully incorporated into the disclosure of the present invention.

A user command may be used to initiate an execution of probable action goals and/or an execution of action goals not specified as probable action goals. Following a user command to carry out an action goal not determined to be a probable action goal in the preparation phase, at least one preparation action sequence aimed at this action goal may be generated and carried out before the start of an execution phase in order to determine object-dependent constraint conditions. The determined object-dependent constraint conditions may be used in the execution phase in at least one execution action sequence.

The user command probability may be determined by means of a mathematical model. The user command probability may be determined by means of a stochastic model, such as a hidden Markov model, a directed acyclic graph, such as a Bayesian network, an undirected probabilistic model, a stochastic process, such as Gaussian process, inverse optimal control with maximum entropy or Laplace's method.

The preparation action sequence and/or an action sequence not yet carried out in the preparation phase may be carried out in real and/or simulative form.

The preparation phase may be carried out continuously. The preparation phase may be carried out at least substantially without interruption. In this respect, the preparation phase may also be referred to as a preparation function. The preparation phase may be carried out with low prioritization with respect to other tasks carried out using the robot. The preparation phase may be carried out in the background. The preparation phase may continue to be carried out while an execution phase is running. The preparation phase may be carried out by means of the robot during the carrying out of tasks. The carrying out of other tasks by means of the robot may include user commands. The preparation phase may be initiated automatically and/or by a user command. The preparation phase may be initiated with a switching on of the robot. The preparation phase may be initiated after completion of an execution phase. The preparation phase may be interrupted, resumed and/or terminated. The preparation phase may be interrupted, resumed and/or terminated automatically and/or by a user command. The preparation phase may be terminated after an initiation of the execution phase.

The robot may be configured to support a user in performing tasks. The robot may be an autonomous mobile robot. The robot may be an assistance robot, a humanoid robot, a personal robot or a service robot. The robot may comprise kinematics. The robot may comprise joints and appendages. The robot may comprise actuators and sensors. The robot may comprise an input and/or output device for a user, which may also be referred to as a user interface. The input and/or output device may be configured to detect user commands. The input and/or output device may be configured to offer a user action goals for selection. The input and/or output device may be configured as a touchscreen. The robot may comprise a control device. The control device may comprise at least one processor, at least one working memory, at least one data memory and/or at least one signal interface. The control device and the input and/or output device may be connected to each other in a signal-transmitting manner. The computer program may be carried out by means of the control device. The robot may be a real robot. The robot may be a simulated robot or a robot simulation.

The robot may comprise a user-triggerable trading system. The trading system may be used to combine input commands of the control module, for example, input commands of a first submodule, such as automation module, and input commands of at least one further submodule, such as a user module, at any time and/or to switch between input commands of a first submodule, such as automation module, and input commands of at least one further submodule, such as user module. Switching between input instructions of a first submodule, such as automation module, and input instructions of at least one further submodule, such as user module, may be initiated by an input instruction of a user to change the execution mode, for example, a support mode.

The computer program may be installable and/or be implementable on a control device of a robot. The computer program may be present as a computer program product. The computer program may be present on a data carrier as an installable and/or implementable program file. The computer program may serve to be loaded into a working memory of a control device of a robot.

In summary and in other words, the invention thus provides, among other things, a method for reducing robot planning times by pre-planning object-dependent constraint conditions with common control with integrated autonomy. A fast and iteratively refined feasibility testing is provided by the invention.

In particular, the invention includes the following features: a planning

system for an assistance robot that may plan tasks in advance (A); the planning system takes the current state of the environment (including the robot) as input and estimates the n most probable actions to be selected (activated) by the user (B), carries out feasibility checks (C), and stores environment-dependent constraints (D) that may make the robot complete a task without colliding with obstacles or having issues with manipulation. The constraints stored in (D) may be used immediately when the user activates one of the verified actions, whereby planning time is saved (F). An action may be activated or started by the user by means of any user interface. The restrictions in the memory in (D) may support the carrying out of tasks in both shared control and supervised autonomy (E). If an action is activated by the user and no object-specific constraint conditions are yet available, these constraint conditions may be calculated at the latest at the moment of activation.

### BRIEF DESCRIPTION OF THE DRAWING

In the following, embodiments of the invention are described in more detail with reference to figures, wherein in a schematic and exemplary manner:

FIG. 1 shows a method for reducing robot planning times by determining object-dependent constraint conditions with common control with integrated autonomy in preparation for the carrying out of a task and

FIG. 2 shows checks of a feasibility with simulated trajectories in preparation for a carrying out of a task.

### DETAILED DESCRIPTION

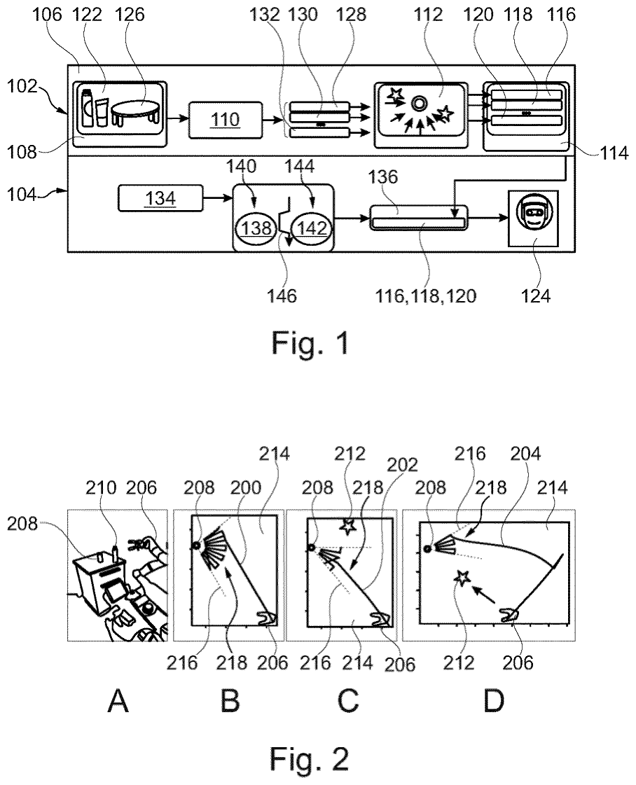

FIG. 1 shows a procedure 100 of a method for reducing robot planning times by means of determination of object-dependent constraint conditions in common control with integrated autonomy in preparation of a carrying out of a task. The method comprises a preparation phase 102 and an execution phase 104.

In the preparation phase 102, a module 106 is used to determine constraint conditions. The module 106 comprises a model 108 of the environment, a submodule 110 for determining a user command probability, a submodule 112 for checking a feasibility of action sequences and a submodule 114 for storing determined constraint conditions, such as 116, 118, 120.

The module 106 is carried out in the background on a continuous basis and uses surroundings information 122, in particular information relating to a state of the robot 124, about a state of parts of the robot 124 and/or about a state of objects present in a working area of the robot 124, such as 126. The surroundings information 122 is updated on a regular basis.

By means of the submodule 110, and taking into account the surroundings information 122, those action goals 128, 130, 132 that a user 134 will most probably select are determined, and preparation action sequences aimed at these probable action goals 128, 130, 132 are generated.

These preparation action sequences are carried out by means of the submodule 112, and tested taking into account both objects 126 of the environment as well as also a position of the robot 124, in particular with respect to obstacles 135 and possible collisions, this to determine feasible paths to reach the action goals 128, 130, 132 that avoid obstacles 135 or areas outside a robot workspace. In so doing, the object-dependent constraint conditions 116, 118, 120, which limit the possible paths for reaching the action goals 128, 130, 132, are determined and stored by means of the submodule 114.

In the execution phase 104, the user 134 then selects one of the action goals 128, 130, 132, whereupon a corresponding execution action sequence 136 is carried out. In so doing, the robot 124 is autonomously controlled under user supervision by means of a user interface 138 in shared control 140 or by means of a greedy algorithm 142 in supervised autonomy 144. The input commands in shared control 140 and the input commands in supervised autonomy 144 use the same action representation. This means that a seamless switch between shared control 140 and supervised autonomy 144 may take place with immediate effect, during the carrying out of the execution action sequence 136, which is indicated in chronological sequence 146 in FIG. 1.

Immediately after selection of one of the action goals 128, 130, 132 by the user 134 and the associated initiation of the execution phase 104, the relevant constraint conditions of the previously determined and stored constraint conditions 116, 118, 120 are retrieved from the submodule 114 and used when carrying out the execution action sequence 136, thereby shortening a response time of the robot 124.

FIG. 2 shows feasibility tests with simulated trajectories 200, 202, 204 in preparation for a carrying out of a task using the example of a gripping task. The task consists of finding a feasible action sequence for gripping a cup 208 placed in front of a robot 206. The arrangement of the cup 208 in front of the robot 206 is shown in scenario A. Scenarios B, C and D are shown with a bottle 210 as an obstacle. There is no obstacle in scenario B. In scenario C, an obstacle 212 is located in the periphery of the workspace 214. In scenario D, an obstacle 212 is located on a direct path between the robot 206 and the cup 208. A boundary 216 of the areas 218 in which a feasible action sequence may be found by means of the method according to the invention is shown in B, C and D with a dashed line. The areas 218 in C and D are each a subset of the area 218 in B.

Initially, the starting position of the robot 206 and the position of the cup 208 to be gripped are determined and the objects are localized by detection. Thereinafter, preparation action sequences are created, carried out and tested by means of the method according to the invention.

Scenarios B, C and D show that preparation action sequences that may be carried out are generated. The approach may be generalized going from a simple workspace 214 without obstacle (scenario B) to workspaces 214 containing obstacles 212 (scenarios C and D). The preparation for the carrying out of a task by means of the method according to the invention is comparatively fast and converges in less than 4 seconds in B and C, wherein 10 out of 10 trials were successful in one experiment. In D, the robot 206 exhausts the local movement possibilities and therefore requires a control engineering plan with reconfiguration, which requires a longer calculation time of slightly more than 11 seconds, with 8 out of 10 trials being successful. Such a situation could have, however, led directly to a failure of the task without a feasibility check. This underlines the advantages of geometric tracing: a reconfiguration only takes place if a local scan is unsuccessful; this reduces planning time in frequent scenarios such as B, whereas a robustness is retained for scenarios such as D.

In order to keep planning times short, trajectories 200, 202, 204 are sampled in two phases: initially, in an exploration phase, an attempt is made to connect a start position with action-related poses from workspace 214, such as, for example, approach pose and grasp pose. The workspace 214 is fully scanned and updated after each scan until a feasible first trajectory section is found. If a feasible first trajectory section exists, the full scanning is ended and a control engineering planner searches the local environment of this first trajectory section in an exploration phase, wherein the planner only tries to add further approach and grasp poses. This is continued up to the boundaries 216 of the area 218. The plan is complete if the distance is greater than a previously defined threshold value. If this is not the case, the exploration phase is started anew. Exemplary trajectories 202, 204 with obstacle 212 are shown in B and C.

In both phases, for geometric tracing, connections with a fast local numerical method for inverse kinematics are attempted, that cannot compute either reconfigurations or large motions. This may work in many situations, but may fail in complex scenarios. In case of failure, in the method according to the invention, the planner starts the exploration phase anew with a global inverse kinematics search, which takes more time and may force the robot 206 to reconfigure itself from its initial position, as shown in D. In addition to FIG. 2, reference is, moreover, in particular, made to FIG. 1 and the associated description.

The term “may” refers in particular to optional features of the invention. Accordingly, there are also further developments and/or embodiment examples of the invention which additionally or alternatively have the respective feature or features.

If necessary, isolated features may also be selected from the feature combinations disclosed herein and used in combination with other features to define the subject matter of the claim, while resolving any structural and/or functional relationship that may exist between the features.

1. A method for preparing and carrying out tasks by means of a robot, characterized in that in a preparation phase at least one probable action goal is determined on the basis of surroundings information and taking into account a user command probability, at least one preparation action sequence is generated which is aimed at the at least one probable action goal, and the at least one preparation action sequence is carried out.

2. The method according to claim 1, characterized in that when carrying out the at least one preparatory action sequence, object-dependent constraint conditions are determined and stored.

3. The method according to claim 2, characterized in that after a user command to carry out a probable action goal, in an execution phase, the stored object-dependent constraint conditions are used in at least one execution action sequence.

4. The method according to at least one of claim 2, characterized in that using the same action representations, the robot is shared in a first support mode and is controlled autonomously under user supervision in a second support mode, wherein the stored object-dependent constraint conditions are used in the first support mode and/or in the second support mode.

5. The method according to claim 1, characterized in that, in the preparation phase, after a user command to carry out an action goal not determined as a probable action goal, at least one preparation action sequence aimed at this action goal is generated and carried out before the start of an execution phase in order to determine object-dependent constraint conditions, and in that the execution phase, the determined object-dependent constraint conditions are used in at least one execution action sequence.

6. The method according to claim 1, characterized in that the user command probability is determined by means of a stochastic model, a directed acyclic graph, an undirected probabilistic model, inverse optimal control with maximum entropy or Laplace's method.

7. The method according to claim 1, characterized in that the preparation action sequence and/or an action sequence not yet carried out in the preparation phase is carried out in real and/or simulative form.

8. The method according to at least one of the preceding claims, characterized in that the preparation phase is carried out continuously in the background.

9. A robot for carrying out tasks, characterized in that the robot configured to carry out a method according to claim 1.

10. A computer program, characterized in that the computer program comprises program code sections with which a method according to claim 1 is implementable when the computer program is carried out on a control device of a robot.
